(19) United States
(12) Patent Application Publication
(10) Pub. No.: US 2009/0122167 A1
(43) Pub. Date: May 14, 2009

(54) Method And Apparatus For Removing Noise By Dark Current Of Image Sensor

(75) Inventor: Yo-Hwan Noh, Gyeonggi-do (KR)

Correspondence Address: HUSCH BLACKWELL SANDERS LLP, 720 OLIVE STREET, SUITE 2400, ST. LOUIS, MO, 63101, US

(73) Assignee: MTEKVISION CO., LTD., Seoul (KR)

(21) Appl. No.: 11/910,995

(22) PCT Filed: Nov. 16, 2005
(86) PCT No.: PCT/KR05/03869

§ 371 Date: Oct. 9, 2007

(30) Foreign Application Priority Data
Apr. 25, 2005 (KR) 10-2005-0034346

(51) Int. Cl. H04N 9/64

(52) U.S. Cl. 348/243; 348/E09.037

(57) ABSTRACT

The present invention is directed to a method and an apparatus for removing noise in an image sensor, more specifically to a method and an apparatus for removing noise caused by a dark current. Through the method for removing noise caused by a dark current that comprises initializing a frame and receiving a digital image signal and converting a value of a clamp bit among bits of the pixel data, included in the digital image signal, to a predetermined value, wherein the clamp bit is a bit stream of sequential digits having a predetermined size comprising a least significant bit among the bits of the pixel data, clearer and shaper images can be displayed through the image sensor.

### CROSS REFERENCE TO RELATED APPLICATIONS

This application is a U.S. National Application of International Application PCT Application No. PCT/KR2005/003869 filed on Nov. 16, 2005, which claims the benefit of priority from Korean Patent Application No. 10-2005-0034346 filed on Apr. 25, 2005. The disclosures of International Application PCT Application No. PCT/KR2005/003869 and Korean Patent Application No. 10-2005-0034346 are incorporated herein by reference.

2. Applicant herewith adds a following paragraph after Page 6, “Mode for Invention”, to correct faulty English set forth in the English translation of the PCT publication and in compliance with 37 CFR 1.52. No new matter is presented.

As used in this application, the terms “part,” “unit” and “module” are intended to refer to a self-contained component of a system, either hardware, a combination of hardware and software, software, or software in execution. For example, a unit can be, but is not limited to being, a process running on a processor, a processor, an electronic circuit executing a process, multiple storage drives (of optical and/or magnetic storage medium), an object, an executable, a thread of execution, a program, and/or a computer. One or more parts, units or modules can reside within an electronic circuit, a process and/or thread of execution.

### TECHNICAL FIELD

The present invention relates to a method and an apparatus for removing noise in an image sensor, more particularly to a method and an apparatus for removing noise caused by a dark current.

### BACKGROUND ART

An image sensor is a device for playing an image using a property of a semiconductor reacting to light. An image sensor consists of an array of small photo diodes, called pixels, which detects brightness and a wavelength of each different light radiated from each subject, reads as an electrical value and makes this to a level that is capable of signal processing. In other words, an image sensor is a semiconductor device transforming an optical image to an electrical signal, and portable devices (for example, digital cameras and mobile communication terminals) having an image sensor have been developed and are being sold.

The image sensor generates a fixed pattern noise by an offset voltage caused by a minute difference in production process. To compensate this, the image sensor uses the CDS (correlated double sampling) method, by which a reset signal and a data signal are read from each pixel of a pixel array before outputting the difference.

Although the image sensor operates at temperatures of 0° C. to 40° C., it must operate at temperatures of over 60° C. without changing its properties while being transported or under a special environment. However, the image sensor consists of semiconductor elements and thus generates an electric current caused by the heat at a high temperature. This is called a dark current, and if the dark current is generated, the image sensor has other electrical signal properties as well as electrical signal properties caused by optical factors. Therefore, a noise, in which a certain level of signal is detected although no light is applied, is generated, and this noise is called a black level.

The black level has a property of shifting up signal components as the temperature increases. The conventional method for preventing the decrease in property by this black level is as follows. FIG. 1 is a diagram showing an optical black area for obtaining an offset value.

Referring to FIG. 1, an image sensor comprises a core pixel array 100 to detect information of an image inputted from outside, a first optical black area 110 and a second optical black area 120 being arranged on one side of the column direction and one side of the row direction of the core pixel array 100 and for calculating an offset value of a black level on constitute pixels. A part 130 shown by enlarging the second optical black area 120 shows that each of the pixels dose not have a consistent value but a different value depending on the magnitude of a signal. A normalized value of the signal magnitudes of the first optical black area 110 and the second optical black area 120 is obtained, and this normalized value is determined to be a compensating value of the black level, that is, a black level offset value. And the black level offset value 220 is evenly subtracted from the entire image data to correct the black level.

Moreover, one of the phenomena by the dark current is a dark current noise. A dark current noise is a phenomenon shown because the property of each pixel cell, which is the smallest unit of an image sensor, is different from each other as illustrated in the part enlarging the second optical black area 120 of FIG. 1. Because of this, although a clean plane is shown, it does not show a uniform and clean image but shows an image having a sizzling noise. There is a problem that this noise cannot be reduced by the conventional subtraction method.

### DISCLOSURE

### [Technical Problem]

Therefore, in order to solve the above problems, it is an object of the present invention to provide a method for removing noise caused by a dark current such that images are shown sharper and clearer.

It is another object of the present invention to provide a method for removing noise that is less affected by the temperature and shows clearer images by clamping noise generated by a dark current.

### [Technical Solution]

In order to achieve the objects described above, an aspect of the present invention can feature a method for removing a noise caused by a dark current. The method can comprise: (a) initializing a frame and receiving a digital image signal; and (b) converting a value of a clamp bit among bits of the pixel data, included in the digital image signal, to a predetermined value. In case the pixel data is comprised of a bit stream of n (natural number) digits expressed in binary number, the clamp bit is a bit stream of sequential digits having a predetermined size comprising a least significant bit among the bits of n digits of the pixel data.

Preferably, the step (b) can comprise: analyzing pixel information of a pixel included in the frame, wherein the digital image signal comprises the pixel information, and the pixel information comprises pixel data indicating a signal size; detecting a maximum value and a minimum value from the pixel data of the pixel located in an optical black area; and setting bits corresponding to a difference between the maximum value and the minimum value as the clamp bits. The step (b) can also comprise converting every value of the clamp bits to a predetermined value of 0 or 1.

In order to achieve the above objects, another aspect of the present invention can feature an apparatus for removing a noise caused by a dark current. The apparatus is connected between a sensor unit and an image data output unit of an image sensor. The apparatus can comprise a digital clamping performing unit, converting and outputting a value of clamp bits among bits of the pixel data included in a digital image signal received from the sensor unit to a predetermined value. In case the pixel data is comprised of a bit stream of n (natural number) digits expressed in binary number, the clamp bits are a bit stream of sequential digits having a predetermined size comprising a least significant bit among the bits of n digits of the pixel data, and image data outputting unit processes pixel data converted by the digital clamping performing unit.

Preferably, the apparatus can further comprise: an optical black area detecting unit, detecting a pixel located in an optical black area, the pixel being in a digital image signal received from the sensor unit; a pixel data analyzing unit, detecting a maximum value and a minimum value from pixel data of the pixel detected by the optical black area detecting unit. The clamp bits can be bits corresponding to a difference between the maximum value and the minimum value of pixel data of the pixel included in the optical black area, and every value of the clamp bits can be converted to 0 or 1.

Additional aspects and advantages of the present general inventive concept will be set forth in part in the description which follows and, in part, will be obvious from the description, or may be learned by practice of the general inventive concept.

### DESCRIPTION OF DRAWINGS

FIG. 1 is a diagram showing an optical black area for obtaining an offset value;

FIG. 2 is a diagram outlining the structure of an apparatus for removing noise according to a preferred embodiment of the present invention;

FIG. 3 is a flowchart of a method for removing noise according to a preferred embodiment of the present invention;

FIG. 4 is a graph showing pixel data of pixels included in an optical black area;

FIG. 5 is a diagram outlining the structure of clamp bits according to a preferred embodiment of the present invention;

FIG. 6 is a diagram illustrating the effect of digital clamping performing unit according to a preferred embodiment of the present invention; and

FIG. 7 is a diagram detailing the effect of digital clamping performing unit according to a preferred embodiment of the present invention.

### MODE FOR INVENTION

Hereinafter, preferred embodiments of a method and an apparatus for removing noise caused by a dark current according to the invention will be described in more detail with reference to the accompanying drawings. In the description with reference to the accompanying drawings, the components that are the same or are in correspondence are assigned the same reference number regardless of the figure number, and redundant explanations are omitted. Also, the basic principles will be described first before discussing the preferred embodiments of the invention.

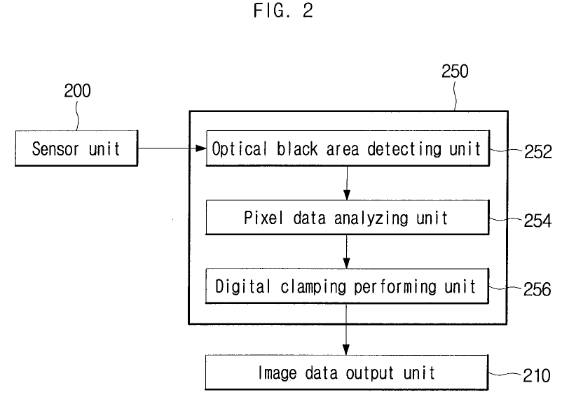

FIG. 2 is a diagram outlining the structure of an apparatus for removing noise according to a preferred embodiment of the present invention. The noise removing apparatus 250 receives image data from a sensor unit 200 and outputs corrected image data, generated by removing noise caused by a dark current, through an image data output unit 210. The noise removing apparatus 250 comprises a digital clamping performing unit 256. The noise removing apparatus 250 can further comprise an optical black area detecting unit 252 and a pixel data analyzing unit 254, for setting the clamp bits, which will be described later. It is preferred that the noise removing apparatus 250 removes noise caused by a dark current frame by frame.

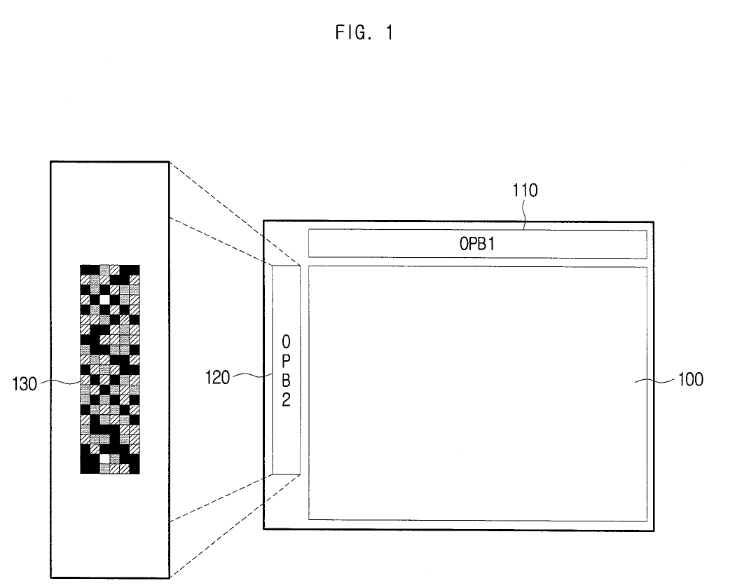

The image data, that is, a digital image signal, received from the sensor unit 200, comprises data of pixels located in the core pixel array 100, the first optical black area 110 and the second black area 120 shown in FIG. 1. The optical black area detecting unit 252 separately detects data of pixels located only in the first optical black area 110 and the second black area 120 of the image data. For verification of noise caused by a dark current, data of an area which is absolutely irrelevant to the optical image is needed, and the data of the first optical black area 110 and the second optical black area 120 qualify for this data. In general, most sensors have the optical black area, which has a light-blocking filter instead of a color filter. Therefore, it is possible to know only pure cell properties of the pixel cell of the image sensor through the properties of cells located in the optical black area.

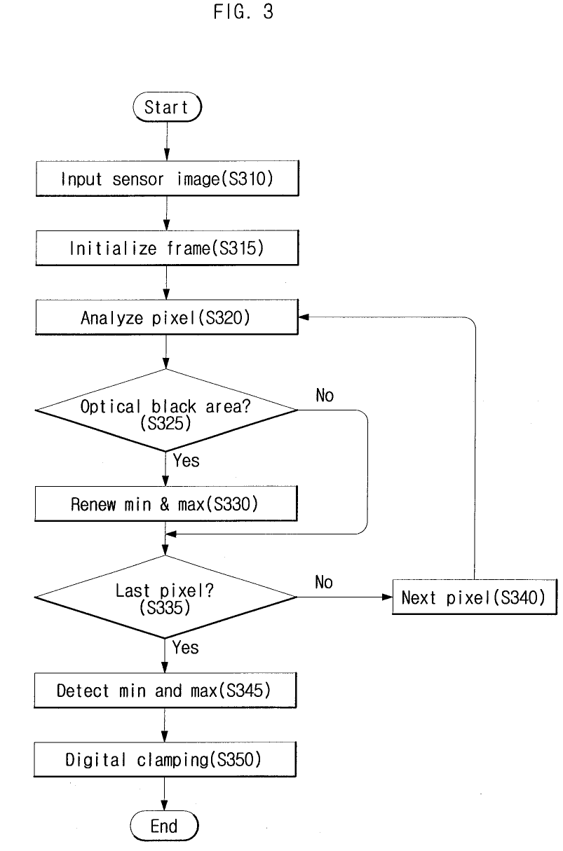

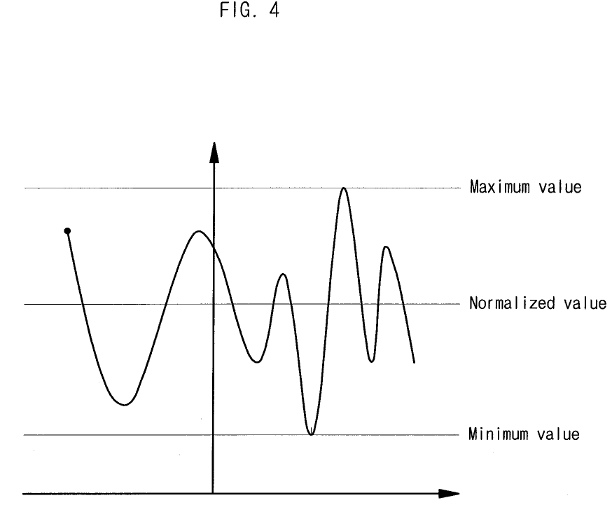

The pixel data analyzing unit 254 analyzes the data of the pixels detected by the optical black area detecting unit 252. The pixel data analyzing unit 254 can comprise a maximum and minimum data detection module (not shown) for checking a dark current noise irregularly shown by a dark current among the data of pixels located in the first optical black area 110 and the second optical black area 120. The function and role of the module are described later with reference to FIGS. 3 and 4.

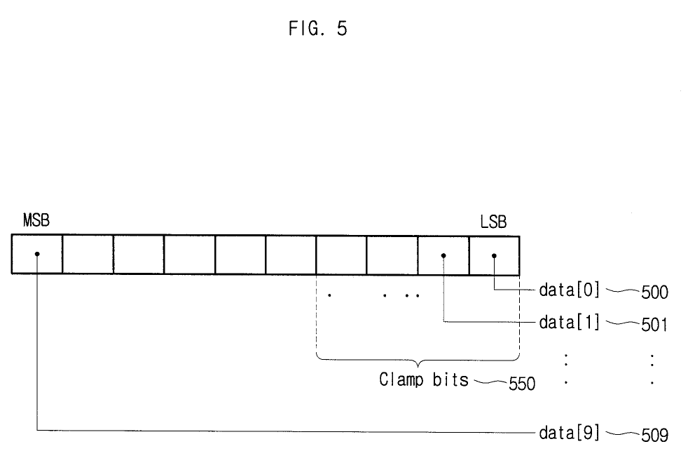

The digital clamping performing unit 256 is digitally clamps the dark current noise caused by the dark current. The pixel data value of the pixels in the area detected by the optical black area detecting unit 252 oscillates irregularly. It has a role of stabilizing the pixel data value by removing some value from the normalized value level. The function and role of the digital clamping performing unit 256 are described later with reference to FIGS. 5-7.

The optical black area detecting unit 252 and the pixel data analyzing unit 254 are for setting the clamp bits. Therefore, it is evident that if information for the clamp bits is predetermined, the optical black area detecting unit 252 and the pixel data analyzing unit 254 can be omitted from the noise removing apparatus 250.

FIG. 3 is a flowchart of a method for removing noise according to a preferred embodiment of the present invention.

Referring to FIG. 3, in step S310, the noise removing apparatus 250 receives the image data of the sensor image inputted through the sensor unit 200. The image data, which is a digital image signal, comprises the location information showing the area in which the pixel of the image data is located. Through this, it is possible whether the image data is included in the first optical black area 110 or the second optical black area 120 (hereinafter, collectively referred to as “optical black area”). The optical black area may be located as shown in FIG. 1, or on top and bottom sides or left and right sides around the core pixel array 100.

In step S315, the frame is initialized. That is, the maximum pixel data value and minimum pixel data value for removing noise caused by a dark current are initialized. Since noise removal is performed one frame at a time, the noise is removed based on different maximum value and minimum value for each frame. Therefore, it is needed to initialize the maximum pixel data value and the minimum pixel data value for each frame.

In step S320, the area, in which the image data received line by line through the sensor unit 200 is located, is analyzed, and the pixel data is detected. The analysis can be performed line by line, on the entire frames or by sampling in the center line.

In step S325, it is determined whether the pixel is included in the optical black area. If the pixel is determined to be not included in the optical black area, step S335 is performed. If the pixel is determined to be comprised in the optical black area, however, in step S330, the maximum value and minimum value of the pixel data, analyzed hitherto, on pixels located in the optical black area are compared with the present pixel data, and the maximum value and minimum value are renewed if necessary.

The graph shown in FIG. 4 shows the pixel data of the pixels included in the optical black area. Each of the pixel data has a specific range of values, in which the minimum value and maximum value are detected. For the detection method, the maximum value and the minimum value can be found under the condition of knowing the information about the entire pixels of the pertinent frame, or the maximum value and the minimum value can be renewed every time the pixel data on each pixel is analyzed. Of course, it is evident that other various methods are possible to detect the maximum value and minimum value.

In a preferred embodiment of the present invention, the maximum and minimum data detection module (not shown) saves the hitherto maximum value and minimum value by continuously comparing the data of the pixels corresponding to the optical black area. After the pixel data of the last pixel of the frame is checked, the maximum value and minimum value are detected among the pixel data in the optical black area.

In steps S335 and S340, it is determined whether the present pixel is the last pixel of the frame, and if the present pixel is not the last pixel, steps S320 to S330 are performed repeatedly. If the present pixel is determined to be the last pixel in step S335, the maximum value and minimum value of the pixel data included in the optical black area of the frame are checked in step S345. Referring to FIG. 4, the normalized value exists between the maximum value and the minimum value. The normalized value may be calculated by dividing the summation of all values of the pixel data included in the optical black area with the number of pixels included in the optical black area.

In step S350, the digital clamping performing unit 256 removes the noise caused by a dark current, using the maximum value and the minimum value (or the normalized value). The function of the digital clamping performing unit 256 will be described below in detail with reference to FIGS. 5-7.

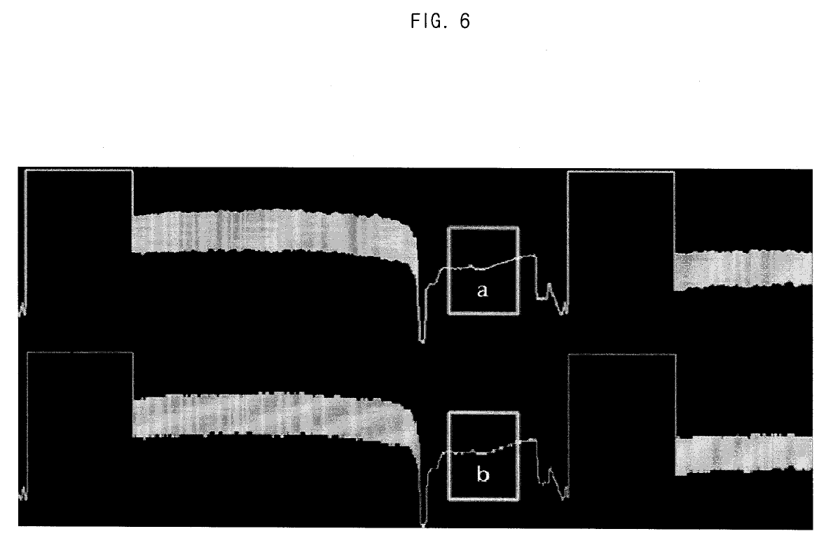

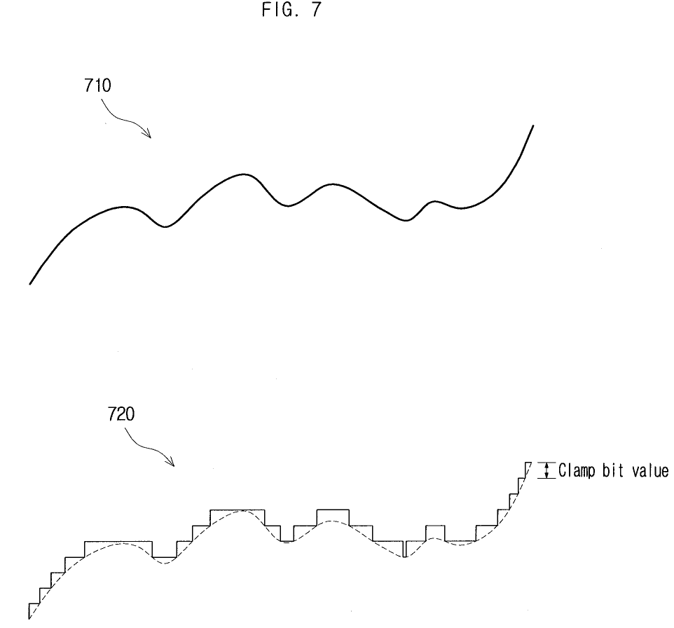

FIG. 5 is a diagram outlining the structure of clamp bits according to a preferred embodiment of the present invention. FIG. 6 illustrates the effect of the digital clamping performing unit according to a preferred embodiment of the present invention. FIG. 7 is a diagram detailing the effect of the digital clamping performing unit according to a preferred embodiment of the present invention.

Referring to FIG. 5, the pixel data has a size of 10 bits. This is only one embodiment, and the pixel data may have another number of bits, for example, 8 bits. The MSB (most significant bit) refers to the biggest digit in the binary number expressed in bit, and the LSB (least significant bit) refers to the smallest digit in the binary number. Assuming that the LSB is data [0] 500 and the MSB is data [9] 509, the bits located in between refer to, in sequence, bits of data [1] through data [8]. Each bit has the value of 0 or 1, and the pixel data may have the value of 0 to 1023 (=2¹⁰−1) because there are 10 bits in the pixel data.

The pixel data having the value as shown in FIG. 4 have values between the maximum value and the minimum value based on the normalized value. With respect to the normalized value, the bits near the LSB, i.e. bits of smaller digit, out of the 10 bits indicating the pixel data only change. In other words, the error is generated by changing the bits of data [0] to data [n], whereby n is a natural number of 9 or smaller and n may be a different value for each frame or the same value for every frame.

Therefore, some of the irregular change or the error, forming the noise, may be offset by making the value of bits of data [0] to data [n] uniform. Here, the bits of data [0] to data [n] are clamp bits 550. If the values of the clamp bits 550 are transformed en bloc to a predetermined value of 0 or 1, the noise caused by the dark current becomes substantially removed. Through this process, the overall image data may be made even.

However, the staircase phenomenon may occur in the image if the clamping by the above processes is excessive. In order to prevent this, it is preferable to determine the size of the clamp bits 550 using the maximum value and the minimum value of the optical black area. The size of the clamp bits 550 may be different according to each frame.

For example, the bits corresponding to half of the difference between the maximum value and the minimum value can be determined to be the clamp bits 550. If the difference between the maximum value and the minimum value is 8, half of the difference is 4, that is, 100 in binary digit, and thus, it affects the bits of data [0] to data [2]. Therefore, the bits of data [0] to data [2] become the clamp bits 550, and the bits corresponding to the clamp bits 550 among the data forming the substantial image included in the core pixel array 100 are changed to 0 or 1 en bloc by force. Because of this, the overall image data can be made even.

In another example, suppose the difference between the maximum value and the minimum value of the pixel data located in the optical black area is 20. Half of 20 is 10, and it is 1010 in binary digit. In this case, 4 bits correspond to the clamp bits, from the LSB, data [0], to data [3], as shown in FIG. 5. The values of data [0] to data [3] are transformed to a predetermined value of 0 or 1 en bloc. If the value is transformed to 1, the transformed data, from which the noise is removed, as shown in FIG. 6, is larger than the actually received pixel data by a range of less than half of the difference between the maximum value and the minimum value. Through this, the noise generated by the dark current can be removed. If the value is transformed to 0, the transformed data, from which the noise is removed, is smaller than the actually received pixel data by a range of less than half of the difference between the maximum value and the minimum value.

Referring to FIG. 6, the upper graph shows the data that is not clamped by the digital clamping performing unit 256, and the lower graph shows the data clamped by the digital clamping performing unit 256. The upper graph shows the continuous oscillation of the upper and lower change of data, but the lower graph shows that the overall data is changing evenly.

FIG. 7 shows the enlarged views of section a and section b in FIG. 6. 710 shown in FIG. 7 is an enlarged view of section a in FIG. 6, and it shows that the pixel data has continuous oscillation due to the upper and lower change. However, 720 shown in FIG. 7 is an enlarged view of section b in FIG. 6, and it shows that the pixel data has a more flat shape because the values having the minute change at an interval of the clamp bits 550 after performing digital clamping transform to have the same value. The height of each staircase is the interval of the clamp bit 550. The staircase phenomenon in the image may be prevented by limiting the interval as described in the above.

The steps S325, S330 and S345, among the steps shown in FIG. 3, are steps for analyzing pixels located in the optical black area in order to determine the clamp bits 550. Therefore, it is evident that, in case the clamp bits 550 are predetermined, steps S325, S330 and S345 maybe omitted.

While the above description has pointed out novel features of the invention as applied to various preferred embodiments, a skilled person will understand that various substitutions and changes in the form and details of the device or process illustrated may be made without departing from the scope of the invention.

### INDUSTRIAL APPLICABILITY

According to the present invention as described above, the method for removing noise caused by a dark current can show images sharper and clearer.

Moreover, by clamping the noise generated by a dark current, the image becomes less affected by the temperature and becomes clearer.

What is claimed is

1. A method for removing a noise caused by dark current of an image sensor, the method comprising:
(a) initializing a frame and receiving a digital image signal; and
(b) removing the noise by converting a value of clamp bits among bits of pixel data included in the digital image signal, to a predetermined value,
wherein, in case the pixel data is comprised of a bit stream of n (natural number) digits expressed in binary number, the clamp bits are a bit stream of sequential digits having a predetermined size and include a least significant bit among the bits of n digits of the pixel data.

2. The method of claim 1, further comprising:
analyzing pixel information of a pixel included in the frame, wherein the digital image signal comprises the pixel information, and the pixel information comprises pixel data indicating a signal size;
detecting a maximum value and a minimum value from the pixel data of the pixel located in an optical black area; and
determining the clamp bits corresponding to a difference between the maximum value and the minimum value.

3. The method of claim 1, wherein the step (b) converts every value of the clamp bits to a predetermined value of 0 or 1.

4. An apparatus for removing a noise caused by a dark current, the apparatus comprising:
a sensor unit, the sensor unit capturing an image;
a digital clamping performing unit, the digital clamping performing unit converting a value of clamp bits among bits of the pixel data included in a digital image signal of the captured image received from the sensor unit to a predetermined value; and
an image data output unit, the image data output unit processing the pixel data converted by the digital clamping performing unit,
wherein, in case the pixel data is comprised of a bit stream of n (natural number) digits expressed in binary number, the clamp bits are a bit stream of sequential digits having a predetermined size comprising a least significant bit among the bits of n digits of the pixel data.

5. The apparatus of claim 4, further comprising:
an optical black area detecting unit, the optical black area detecting unit detecting a pixel located in an optical black area, the pixel being in a digital image signal received from the sensor unit;
a pixel data analyzing unit, the pixel data analyzing unit detecting a maximum value and a minimum value from the pixel data of the pixel detected by the optical black area detecting unit,
wherein the clamp bits are bits corresponding to a difference between the maximum value and the minimum value of pixel data of the pixel included in the optical black area.

6. The apparatus of claim 4, wherein every value of the clamp bits is converted to 0 or 1.

7. An apparatus for removing a noise caused by a dark current, the apparatus comprising:
a sensor unit, the sensor unit capturing an image;
means for converting a value of clamp bits among bits of the pixel data included in a digital image signal of the captured image received from the sensor unit to a predetermined value; and
means for processing the pixel data converted by the means for converting the value of clamp bits,
wherein, in case the pixel data is comprised of a bit stream of n (natural number) digits expressed in binary number, the clamp bits are a bit stream of sequential digits having a predetermined size comprising a least significant bit among the bits of n digits of the pixel data.

8. The apparatus of claim 7, further comprising:
means for detecting a pixel located in an optical black area, the pixel being in a digital image signal received from the sensor unit;
means for detecting a maximum value and a minimum value from the pixel data of the pixel detected by the means for detecting the pixel located in the optical black area,
wherein the clamp bits are bits corresponding to a difference between the maximum value and the minimum value of pixel data of the pixel included in the optical black area.

9. An apparatus for removing a noise caused by a dark current, the apparatus comprising:
means for initializing a frame and receiving a digital image signal; and
means for removing the noise by converting a value of clamp bits among bits of pixel data included in the digital image signal, to a predetermined value,
wherein, in case the pixel data is comprised of a bit stream of n (natural number) digits expressed in binary number, the clamp bits are a bit stream of sequential digits having a predetermined size and include a least significant bit among the bits of n digits of the pixel data.

10. The apparatus of claim 9, further comprising:
means for analyzing pixel information of a pixel included in the frame, wherein the digital image signal comprises the pixel information, and the pixel information comprises pixel data indicating a signal size;
means for detecting a maximum value and a minimum value from the pixel data of the pixel located in an optical black area; and
means for determining the clamp bits corresponding to a difference between the maximum value and the minimum value.
